(19) United States
(12) Patent Application Publication
(10) Pub. No.: US 2016/0072189 A1
(43) Pub. Date: Mar. 10, 2016

(54) ANTENNA ASSEMBLY AND ELECTRONIC DEVICE COMPRISING SAID ANTENNA ASSEMBLY

(71) Applicant: THOMSON LICENSING, Issy de Moulineaux (FR)

(72) Inventors: Dominique Lo Hine Tong, Rennes (FR); Philippe Minard, Saint Medard Sur Ille (FR); Pierre-Marie Morin, Sainte Gemmes Sur Loire (FR); Jean-Marc Le Foulgoc, Bourgbarre (FR)

(21) Appl. No.: 14/845,630

(22) Filed: Sep. 4, 2015

(30) Foreign Application Priority Data
Sep. 5, 2014 (EP) 14306372.5
Nov. 3, 2014 (EP) 14306755.1

(51) Int. Cl. H01Q 9/20

(52) U.S. Cl. CPC H01Q 9/20

(57) ABSTRACT

An antenna assembly mountable on a circuit board, the antenna assembly comprising a radiating part; a transmission part for feeding the radiating part the transmission part comprising a signal feed element and a ground element connectable to the circuit board; wherein: the ground element comprises an extension ground portion, folded away from a first ground portion such that it extends over the signal feed element and the first ground portion to form a ground plane cover spaced apart from the signal feed element and connectable to a ground connection of the circuit board.

### TECHNICAL FIELD

The present invention relates to an antenna assembly and a wireless electronic device comprising said antenna assembly.

### BACKGROUND

Electronic wireless devices including mobile telephones, tablets set-top boxes and gateway devices contain an increasing number of electronic components in an increasingly reduced space.

FIG. 10 shows an example of a configuration of electronic components in a set-top box 11. As illustrated, the front side of the circuit board is fully occupied by many electronic components, such as a display device 1, an infra-red sensor 2, a group of LEDS 3, a group of control push-buttons 4, a SD-card reader 5, and USB connectors 6. All of these electronic components are aligned along the front edge of the circuit board due to their functionality and usage.

An important functional element of such wireless devices is the antenna for transmission and reception of radio frequency waves. The optimum place for positioning an antenna is at the front of the wireless device. However, the presence of the many other electronic components at the front of a wireless device creates obstacles to the radiation of radio waves and impairs the performance of the antenna. Moreover, in some configurations large areas of ground clearance need to be provided on the circuit board to provide appropriate grounding of the antenna. Because of the presence of the other electronic components it is becoming increasingly difficult to find the required space for ground clearance of antennas at the front side of the circuit board.

The present invention has been devised with the foregoing in mind.

### SUMMARY

A first aspect of the invention provides an antenna assembly mountable on a circuit board, the antenna assembly comprising: a radiating part; a transmission part for feeding the radiating part, the transmission part comprising a signal feed element and a ground element connectable to the circuit board; wherein the ground element comprises a first ground portion extending in a longitudinal direction alongside the signal feed element and an extension ground portion extending laterally from the first ground portion, the extension ground portion being folded to form a ground plane extending over both the signal feed element and the first ground portion and spaced apart from the signal feed element, the extension ground portion being connectable to a ground connection of the circuit board.

In an embodiment the first ground portion and the extension ground portion are formed as a single grounding unit.

In an embodiment, the signal feed element and the first ground portion extend parallel to one another.

In an embodiment, the signal feed element operates in a microstrip mode.

In an embodiment, the signal feed element is fed by a coplanar waveguide with ground.

In an embodiment the extension ground element is folded to provide a ground plane on each side of the signal feed element.

In an embodiment, a transmission line interface is provided for connecting the signal feed element to the circuit board, wherein an aperture is defined in the extension ground portion at the part of the extension ground portion facing towards the transmission line interface.

In an embodiment, the radiating element comprises an Inverted F Antenna.

In an embodiment, the radiating part comprises a ground element extending from the first ground portion of the transmission part and a signal element extending from the signal feed element of the transmission part and a radiating element extending perpendicularly to the ground element and the signal element.

In an embodiment, the radiating element is folded along its longitudinal axis.

In an embodiment, the radiating element comprises a monopole type antenna

In an embodiment, the extension ground portion is folded along a further axis such that it extends parallel to the ground element and the signal element of the radiating element.

In an embodiment, the ground extension portion is located on an opposite side of the signal feed element and the first ground portion of the transmission part, to the radiating element.

In an embodiment, the ground extension portion is located on the same side of the signal feed element and the first ground portion of the transmission part, as the radiating element.

In an embodiment the radiating element is a monopole. In another embodiment the radiating element is a dipole.

In an embodiment the transmission part is configured to adapt the impedance of the radiating part. For example, the impedance of the radiating part is adapted to match the input impedance of the transmission part. In one embodiment the height of the transmission part is set to a quarter wavelength.

Another aspect of the invention provides an antenna assembly mountable on a circuit board, the antenna assembly comprising: a radiating part; a transmission part for feeding the radiating part, the transmission part comprising a signal feed element and a ground element connectable to the circuit board; wherein: the ground element comprises a first ground portion extending alongside the signal feed element and a ground plane extending over both the signal feed element and the first ground portion and spaced apart from the signal feed element, the ground plane being connectable to a ground connection of the circuit board.

The first ground portion and the ground plane may be formed as a single grounding unit.

A second aspect of the invention provides an electronic communication device comprising a circuit board and an antenna assembly according to any preceding claim mounted on the circuit board, the antenna assembly being mounted such that the a signal feed element and a first ground portion of the transmission part extend away from the surface of the circuit board.

In an embodiment, the circuit board is provided with at least one electronic component at the front of the circuit board and the radiating part is arranged to extend from the transmission part beyond the electronic component to the front of the electronic component and to face outwards from the electronic communication device, the transmission part being disposed behind the electronic component.

In an embodiment, the electronic comprises at least one of a display board, an LED, an infra-red sensor, a control unit, and a USB connector.

In an embodiment, the circuit board comprises a clearance area devoid of electronic components, the clearance area being disposed behind the antenna assembly.

In an embodiment, the electronic communication device is a gateway device or a set top box.

A further aspect of the invention provides an antenna assembly mountable on a circuit board, the antenna assembly comprising: a radiating part; a transmission part for feeding the radiating part, the transmission part comprising a signal feed element and a ground element connectable to the circuit board; wherein the ground element comprises an extension ground element, folded away from the ground element such that it extends from the ground element over the signal feed element and the ground element to form a ground plane spaced apart from the signal feed element and connectable to a ground connection of the circuit board.

### BRIEF DESCRIPTION OF THE DRAWINGS

Embodiments of the invention will now be described, by way of example only, and with reference to the following drawings in which:

FIG. 1 is a schematic diagram of an antenna assembly according to a first embodiment of the invention;

FIG. 2 is a schematic diagram of the antenna assembly of FIG. 1 mounted on a PCB;

FIG. 3A is a planar view of a PCB on which the antenna assembly of FIG. 1 is mounted;

FIG. 3B is a perspective view of the antenna assembly of FIG. 1 mounted on the PCB of FIG. 3A;

FIG. 4A is a perspective view of a PCB, having a display panel, on which the antenna assembly of FIG. 1 is mounted;

FIG. 4B is another perspective view of the PCB, having a display panel, on which the antenna assembly of FIG. 1 is mounted;

FIG. 5 is a schematic diagram of an antenna assembly according to a second embodiment of the invention;

FIG. 6 is a schematic diagram of an antenna assembly according to a third embodiment of the invention;

FIG. 7 is a schematic diagram of an antenna assembly according to a fourth embodiment of the invention;

FIGS. 8A and 8B are schematic diagram of an antenna assembly according to a fifth embodiment of the invention;

FIG. 9 is a perspective view of an electronic device provided with a plurality of antenna assemblies in accordance with embodiments of the invention; and

FIG. 10 is a perspective view of an example of a wireless electronic device.

### DETAILED DESCRIPTION

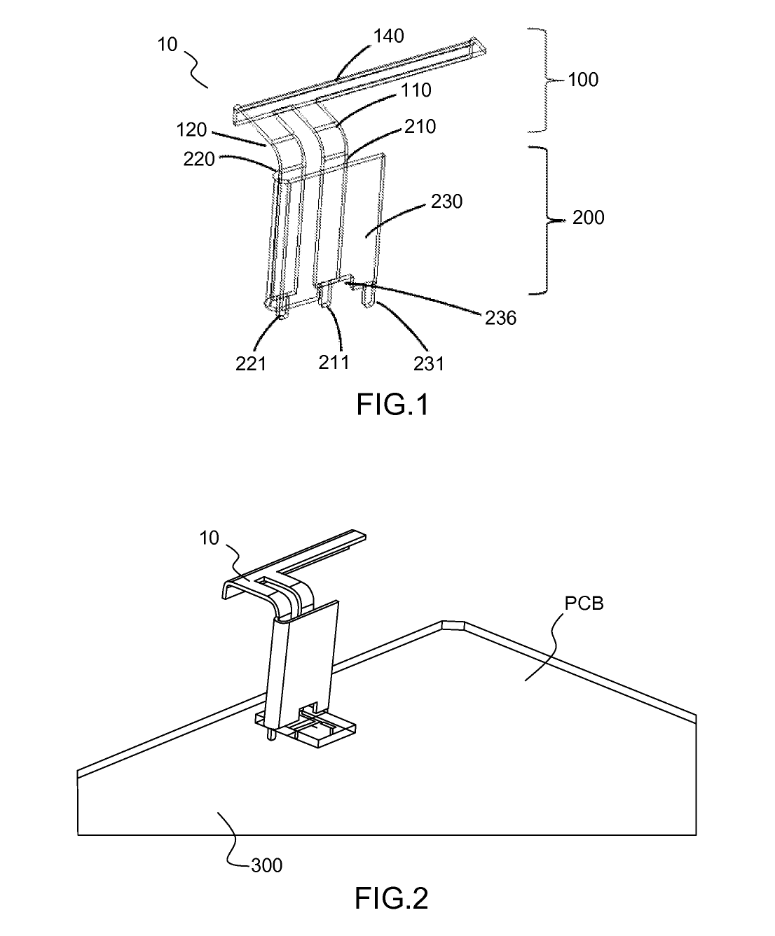

FIG. 1 is a schematic diagram of an antenna assembly according to a first embodiment of the invention. The antenna assembly 10 comprises a radiating part 100 for radiating radio frequency signals and a transmission part 200 for feeding signals from a feed line of a printed circuit board (PCB) on which the antenna assembly 10 is mounted to the radiating part 100.

The transmission part 200 comprises a signal feed element in the form of a signal strip 210 for feeding signals from the PCB to the radiating part 100 and a ground element comprising ground strip 220 connectable to a ground connection of the PCB. The signal strip 210 and the ground strip 220 are arranged to extend parallel to one another. The ground strip 220 forms a first ground portion extended by an extension ground portion in the form of extension ground element. The extension ground element extends laterally from one side of the ground strip 220 and is curved through an angle of approximately 180° to form a ground plane 230 parallel to and spaced apart from the main surfaces of the ground strip 220 and the signal element 210. The ground plane 230 is connectable to a ground connection of the PCB. In this configuration the signal strip 210 is in a microstrip mode with a finite ground plane provided by ground plane 230.

An aperture 236 is defined in the ground plane 230 at the part of the ground plane 230 facing the interface between the signal strip 210 and the PCB. This enables electrical contact between the ground plane 230 and the feeding line of the PCB to be avoided. The signal strip 210 is provided with a pin 211 for connecting to a corresponding connection on the signal feeding line of the PCB. The ground strip 220 is provided with a pin 221 for connecting to a corresponding connection on the ground plane of the PCB, and the extension ground plane 230 is provided with a pin 231 for connecting to a corresponding connection on the ground plane of the PCB.

The radiating part 100 comprises a signal strip 110 extending from the signal strip 210 of the transmitting part, and a ground strip 120 extending from the ground strip 220 of the transmitting part. The signal strip 110 and the ground strip 120 are bent at an angle of approximately 90° to the signal strip 210 and the ground strip of the transmitting part. A radiating strip 140 connects the ends of the signal strip 110 and the ground strip 120 to form an IFA type antenna. The radiating strip 140 is folded along its longitudinal axis by an angle of approximately 90°. Such a configuration enables the antenna input impedance matching to be optimized.

The transmission part 200 may also serve as an impedance matching line. The transmission part 200 may adapt the impedance of the antenna part 100 to its input impedance. In one particular embodiment the height of the transmission part may correspond to a quarter wavelength. The height of the transmission part is determined by the length of the signal strip 210 and ground strip 220.

FIG. 2 schematically illustrates the antenna assembly of FIG. 1 mounted on a PCB board 300.

The signal strip 210 and the ground strip 220 of the transmission part 200 of the antenna assembly 10 extend from the surface of the PCB board 300. The radiating part 100 of the antenna assembly 200 is thereby raised a height above the surface of the PCB board 300, the height being dependent upon the length of the signal strip 210 and the ground strip 220 of the transmission part 200. The clearing height enables the radiating part 100 to be disposed above an electronic component fitted on the PCB board 300 in front of the transmission part 200 which would otherwise act as an obstacle to radiation of the radiating strip 140. The extension of the signal strip 110 and the ground strip 120 at a right angle from the signal strip 210 and the ground strip 220 of the transmission part 200 enables the radiating strip 140 to extend beyond the electronic component thereby providing an obstacle free zone in front of the radiating strip 140.

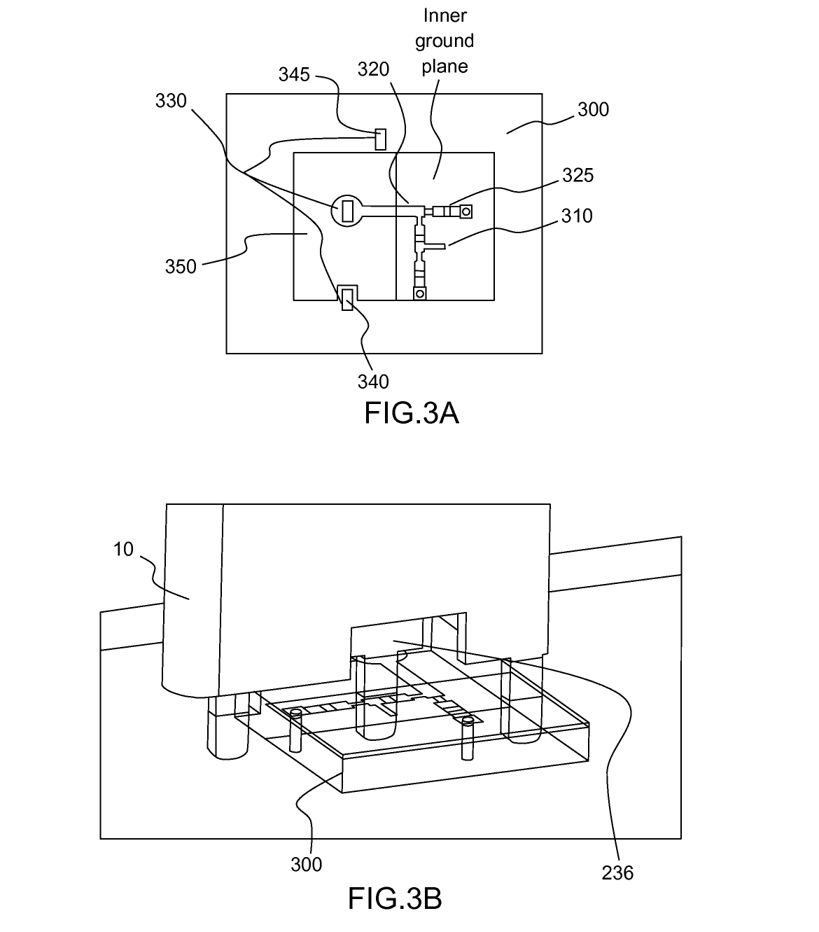

FIG. 3A schematically illustrates the surface of the PCB 300 where the antenna assembly 10 is mounted, and FIG. 3B schematically illustrates the antenna assembly 10 mounted on the PCB board. The PCB 300 comprises a feeding port 310 for feeding the signal, a feed line 320 for connecting the feeding port 310 to the signal feed connector 330 for receiving the signal feed pin 211 of the transmission part 200. A first ground pin connector 340 is provided for connecting with the ground pin 221 of the ground strip 220, and a second ground pin connector 345 is provided for connecting with the ground pin 231 of the ground plane 230. The first ground pin connector 340 and the second ground pin connector 345 are connected to a ground plane of the PCB 300. Impedance matching components 325 are provided on the feed line 320. A clearance area 350 devoid of connections for mounting electronic components is provided around the signal feed connector 330. Aperture 236 in the ground plane 230 is aligned with the signal feed connector 330.

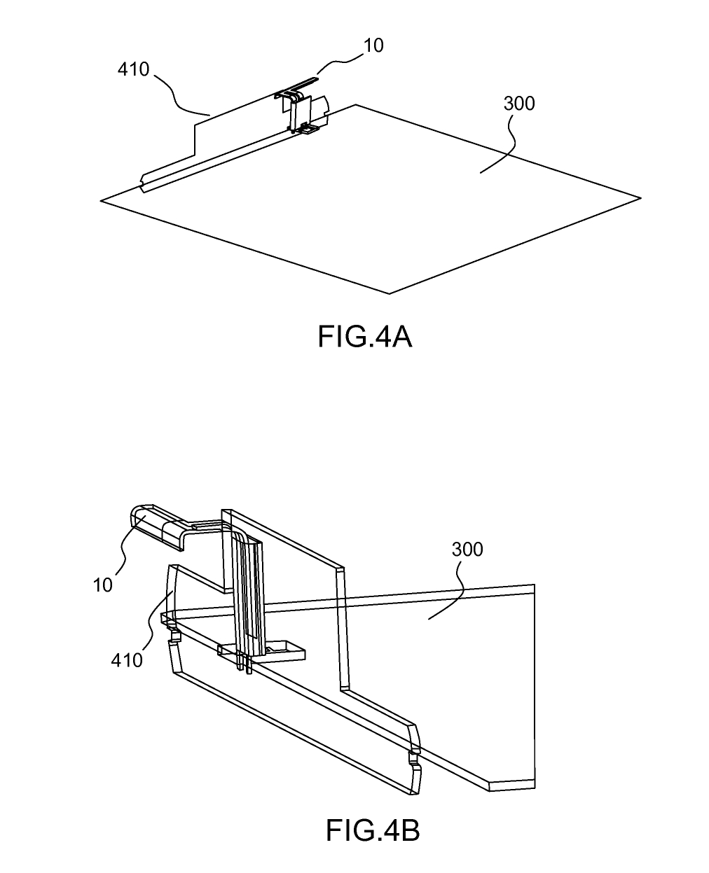

FIGS. 4A and 4B schematically illustrate the PCB board 300 of FIG. 2 fitted with a display panel 410 at the front side of the PCB board 300. The antenna assembly 10 is arranged with respect to the display panel 410 such that the transmission part 200 is disposed behind the display panel 410 and the antenna part 100 is disposed in front of the display panel 410. The clearance height provided by the length of the signal feed strip 210 and the ground strip 220 of the transmission part 200 enables the antenna part 100 of the antenna assembly 10 to be disposed over the display panel 410, and the orientation of the signal strip 110 and the ground strip 210 extending perpendicularly to the transmission part 100 enables the radiating element 140 of the antenna part 10 to be disposed in front of the display panel 410.

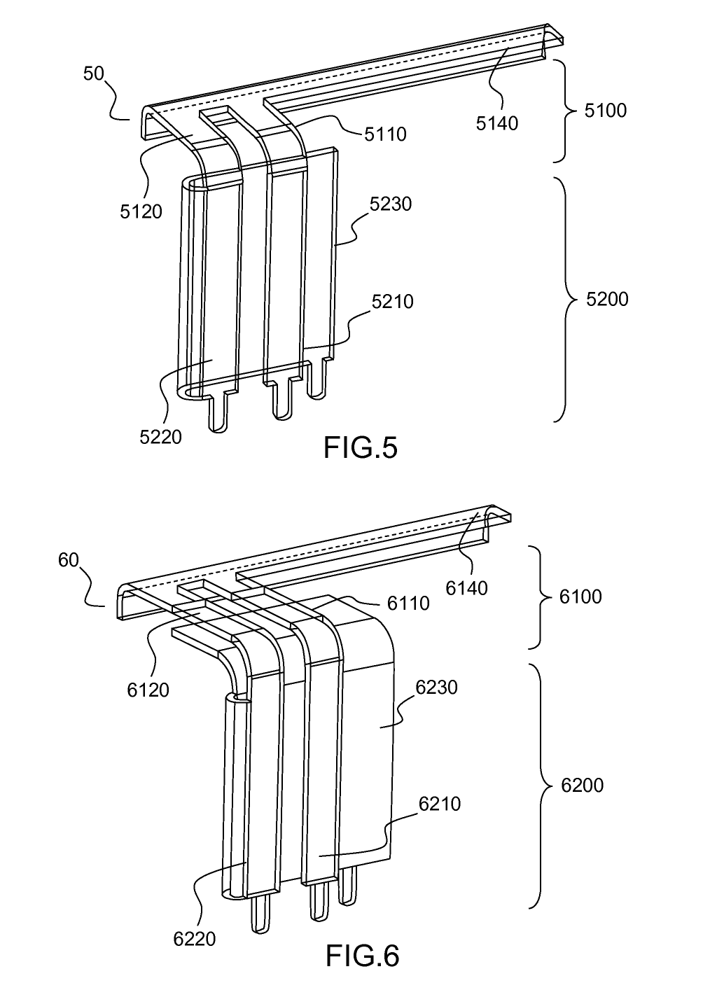

FIG. 5 is a schematic diagram of an antenna assembly 50 according to a second embodiment of the invention. The antenna assembly 50 comprises a radiating part 5100 for radiating radio frequency signals and a transmission part 5200 for feeding signals from a feed line of a printed circuit board (PCB) on which the antenna assembly 50 is mounted to the radiating part 5100. The antenna assembly 50 of the second embodiment differs to the antenna assembly 10 of the first embodiment in that the ground plane 5230 of the transmission part is located on the same side of the signal feed strip 5210 and the ground strip 5220 as the radiating element 5140 of the radiating part 5100 relative to the signal feed strip 5210.

FIG. 6 is a schematic diagram of an antenna assembly 60 according to a third embodiment of the invention. The antenna assembly 60 comprises a radiating part 6100 for radiating radio frequency signals and a transmission part 6200 for feeding signals from a feed line of a printed circuit board (PCB) on which the antenna assembly 60 is mounted to the radiating part 6100. The antenna assembly 60 of the third embodiment differs to the antenna assembly 50 of the second embodiment in that part of the ground plane 6230 of the transmission part 6200 is bent to extend away from the main part of the ground plane 6230 parallel to the signal strip 6110 and ground strip 6120 of the radiating part 6100 of the antenna assembly 60 towards the radiating element 6140 of the radiating part 6100.

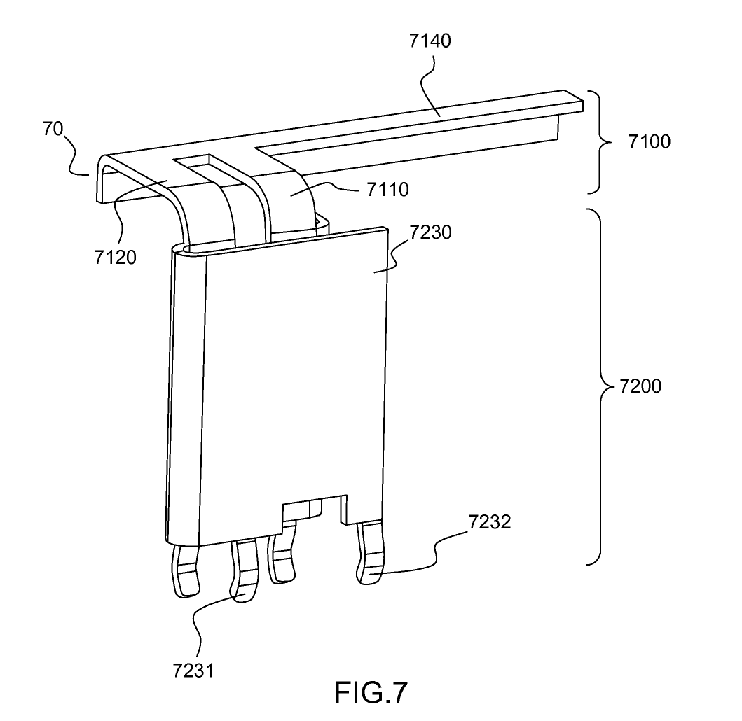

FIG. 7 is a schematic diagram of an antenna assembly 70 according to a fourth embodiment of the invention. The antenna assembly 70 comprises a radiating part 7100 for radiating radio frequency signals and a transmission part 7200 for feeding signals from a feed line of a printed circuit board (PCB) on which the antenna assembly 70 is mounted to the radiating part 7100. The antenna assembly 70 of the fourth embodiment differs to the antenna assembly 10 of the first embodiment in that the ground plane 7230 of the transmission part 7200 is provided with two ground connector pins 7231 and 7232, and in that the signal feed strip 7210 is wider, and may be slightly bent. This enables a more rigid assembly to be provided. Ground connector pins 7231 and 7232 may be bent to ensure better hold of the antenna when it is being mounted on the PCB and when it is being fixed to the PCB, for example by soldering.

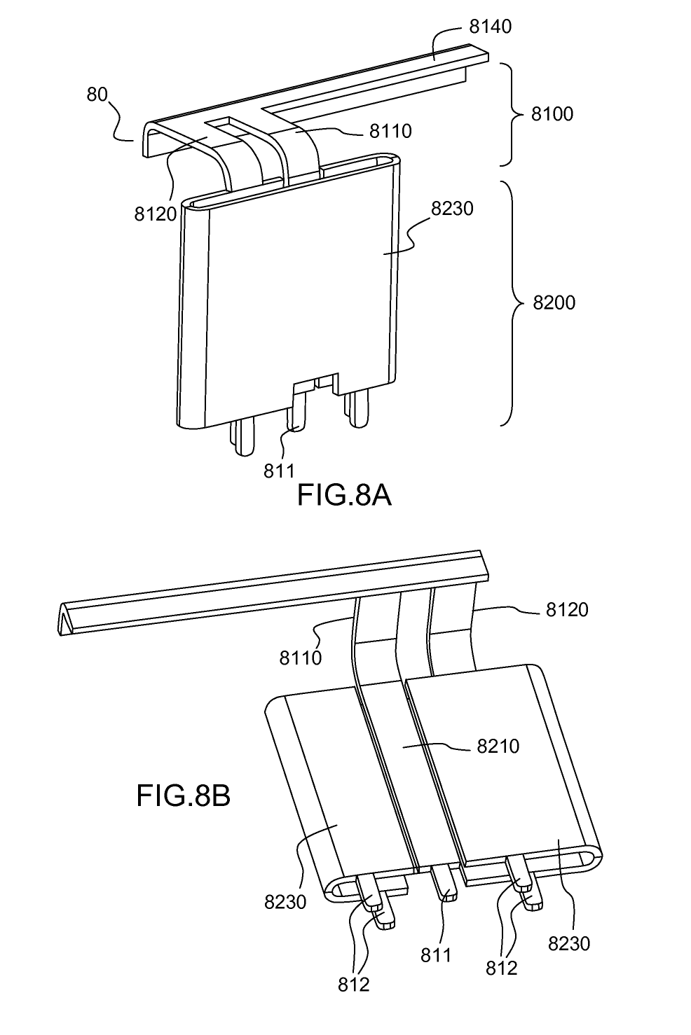

FIGS. 8A and 8B are schematic diagrams of an antenna assembly 80 according to a fifth embodiment of the invention. In this embodiment of the invention the antenna assembly is fed by a coplanar waveguide with ground (CPWG). The antenna assembly 80 comprises a radiating part 8100 for radiating radio frequency signals and a transmission part 8200 for feeding signals from a CPWG to the radiating part 8100 by a feed line strip 8210. In this embodiment of the invention the transmission part 8200 comprises a ground element and a feed line strip 8210. The ground element comprises first ground plane portions each extending in a direction away from and spaced apart from respective side edges of the feed line strip 8210 and folded to form a second ground plane 8230 parallel to the first ground plane portions. The second ground plane 8230 faces towards and is spaced apart from major surface of the feed line strip 8210 and the major surfaces of the first ground plane portions. The ground element is provided with four connections 812 for connection to a ground of the PCB

The radiating part 8100 comprises a signal strip 8110 extending from the signal strip 8210 of the transmitting part, and a ground strip 8120 extending from the ground plane 8230 of the transmitting part. The signal strip 8110 and the ground strip 8120 are bent at an angle of approximately 90° to the feed line strip 8210 and the ground plane 8230 of the transmitting part. A radiating strip 8140 connects the ends of the signal strip 8110 and the ground strip 8120 to form an IFA type antenna. The radiating strip 8140 is folded along its longitudinal axis by an angle of approximately 90°.

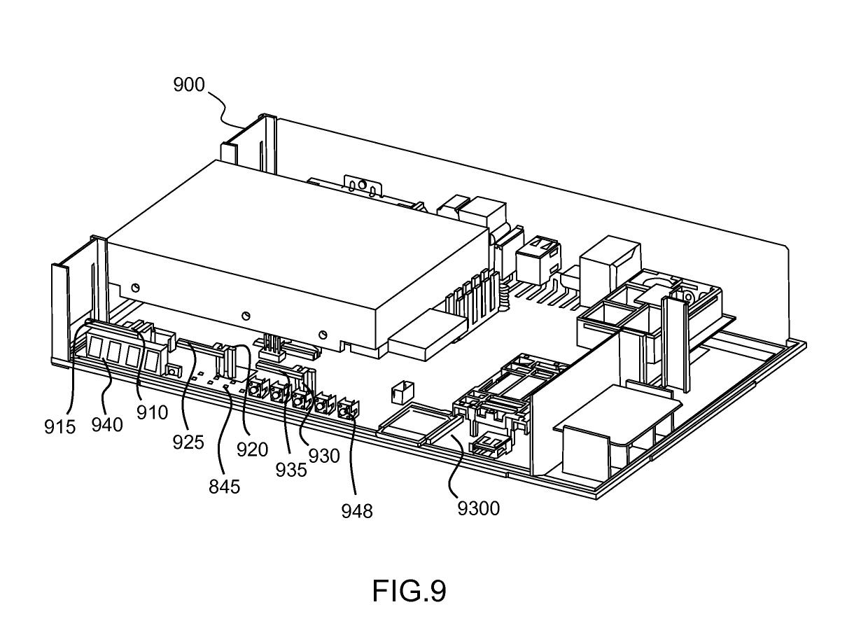

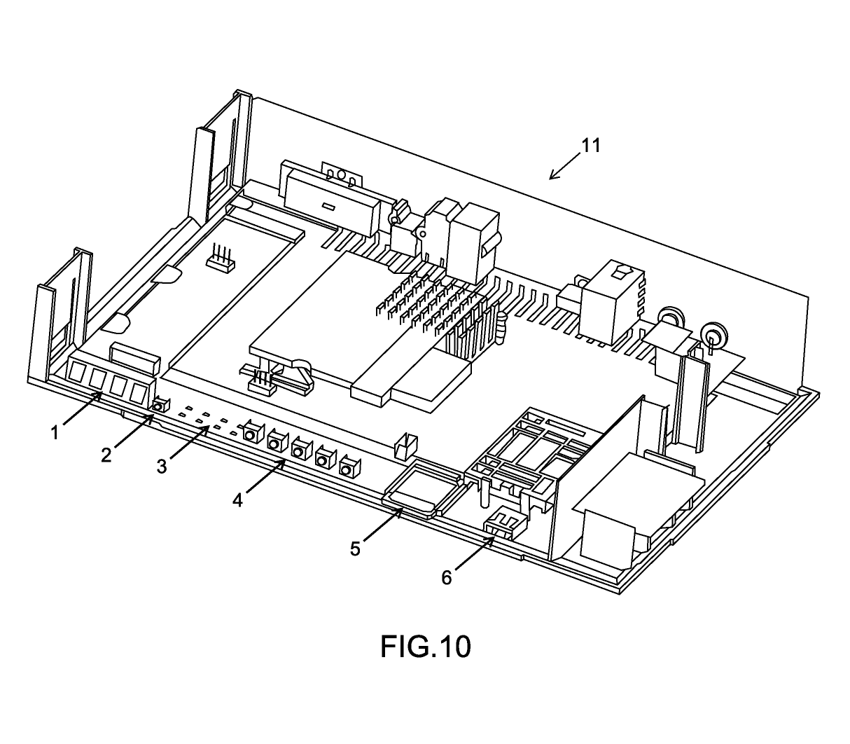

FIG. 9 is a perspective view of an electronic device 900 having a PCB 9300, on which are mounted three antenna assemblies 910, 920 and 930 according to any of the embodiments of the invention. The first antenna assembly 910 is connected to the PCB 9300 behind a display 940 such that the transmission part of the antenna assembly 910 is located behind the display and the radiating element 915 is disposed above and in front of the display 940. The second antenna assembly 920 is connected to the PCB 9300 behind a set of LEDs 945 such that the transmission part of the antenna assembly 920 is located behind the set of LEDs 945 and the radiating element 925 is disposed above and in front of the set of LEDs 945. The third antenna assembly 930 is connected to the PCB 9300 behind a set of push buttons 948 such that the transmission part of the antenna assembly 930 is located behind the set of push buttons 948 and the radiating element 935 is disposed above and in front of the set of push buttons 948.

Embodiments of the invention enable the ground clearance surface area on the PCB to be drastically reduced, freeing more space for the integration of other components. Any obstructions and obstacles placed in the front side of a main board, such as a barrier of LEDS and mechanical push-buttons, a display board or other plastic and metal parts, can be by-passed implementing an antenna assembly according to embodiments of the invention enabling thus an improved radiation performance of the antenna.

Moreover the antenna assembly according to embodiments of the invention can be manufactured at reduced cost, using common manufacturing technologies, for example by stamping process.

In addition an antenna assembly according to embodiments of the invention can be placed not only at the edge of a PCB but towards the inner part of the PCB, close to RF transceiver output, thereby reducing insertion losses by virtue of the transmission line being integrated with the antenna assembly in a single metal part. The integrated transmission line may also serve as an impedance matching line, avoiding the need to provide impedance matching on the main board using printed transmission line or lumped components (inductors, capacitors).

The antenna assembly according to embodiments of the invention may operate as a monopole or a dipole.

Although the present invention has been described hereinabove with reference to specific embodiments, the present invention is not limited to the specific embodiments, and modifications will be apparent to a skilled person in the art which lie within the scope of the present invention.

For instance, while the foregoing examples have been described with respect to a set top box it will be appreciated that the invention may be applied to any other wireless electronic communication device employing an antenna.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

1. An antenna assembly mountable on a circuit board, the antenna assembly comprising:
a radiating part;
a transmission part for feeding the radiating part, the transmission part comprising a signal feed element and a ground element connectable to the circuit board; wherein:
the ground element comprises a first ground portion extending in a longitudinal direction alongside the signal feed element and an extension ground portion extending laterally from the first ground portion, the extension ground portion being folded to form a ground plane extending over both the signal feed element and the first ground portion and spaced apart from the signal feed element, the extension ground portion being connectable to a ground connection of the circuit board.

2. An antenna assembly according to claim 1, wherein the first ground portion and the extension ground portion are formed as a single grounding unit.

3. An antenna assembly according to claim 1, wherein the signal feed element and the first ground portion extend parallel to one another.

4. An antenna assembly according to claim 1, wherein the signal feed element operates in a microstrip mode.

5. An antenna assembly according to a claim 1, comprising a transmission line interface for connecting the signal feed element to the circuit board, wherein an aperture is defined in the extension ground portion at the part of the extension ground portion facing towards the transmission line interface.

6. An antenna assembly according to claim 1, wherein the radiating element comprises an Inverted F Antenna.

7. An antenna assembly according to claim 6, wherein the radiating part comprises a ground element extending from the first ground portion of the transmission part and a signal element extending from the signal feed element of the transmission part and a radiating element extending perpendicularly to the ground element and the signal element.

8. An antenna assembly according to claim 7, wherein the radiating element is folded along its longitudinal axis

9. An antenna assembly according to claim 1, wherein the radiating element comprises a monopole type antenna

10. An antenna assembly according to claim 1, wherein the extension ground portion is folded along a further axis such that it extends parallel to the ground element and the signal element of the radiating element.

11. An antenna assembly according to claim 1, wherein the ground extension portion is located on an opposite side of the signal feed element and the first ground portion of the transmission part, to the radiating element.

12. An antenna assembly according to claim 1, wherein the ground extension portion is located on the same side of the signal feed element and the first ground portion of the transmission part, as the radiating element.

13. An electronic communication device comprising
a circuit board and
an antenna assembly mounted on the circuit board and comprising:
a radiating part;
a transmission part for feeding the radiating part, the transmission part comprising a signal feed element and a ground element connectable to the circuit board; wherein the ground element comprises a first ground portion extending in a longitudinal direction alongside the signal feed element and an extension ground portion extending laterally from the first ground portion, the extension ground portion being folded to form a ground plane extending over both the signal feed element and the first ground portion and spaced apart from the signal feed element, the extension ground portion being connectable to a ground connection of the circuit board.
the antenna assembly being mounted such that the signal feed element and the first ground portion of the ground element of the transmission part extend away from the surface of the circuit board.

14. An electronic communication device according to claim 13 wherein the circuit board is provided with at least one electronic component at the front of the circuit board and the radiating part is arranged to extend from the transmission part beyond the electronic component to the front of the electronic component and to face outwards from the electronic communication device, the transmission part being disposed behind the electronic component.

15. An electronic communication device according to claim 14 wherein the at least one electronic component comprises at least one of a display board, an LED, an infra-red sensor, a control unit, and a USB connector.

16. An electronic communication device according to claim 13 wherein the circuit board comprises a clearance area devoid of electronic components, the clearance area being disposed behind the antenna assembly.

17. An electronic communication device according to claim 13 wherein the electronic communication device is a gateway device or a set top box.
